(19) United States
(12) Patent Application Publication
(10) Pub. No.: US 2005/0217658 A1
(43) Pub. Date: Oct. 6, 2005

(54) Shelf arrangement for ovens

(75) Inventors: Valdeon Sozo, Joinville-SC (BR); Alvaro Simoes de Paiva Neto, Joinville-SC (BR); Andre Dalgas Tomm, Joinville-SC (BR)

Correspondence Address: DARBY & DARBY P.C., P. O. BOX 5257, NEW YORK, NY, 10150-5257, US

(73) Assignee: Multibras S.A. Eletrodomesticos, Sao Paulo-SP (BR)

(21) Appl. No.: 10/525,879

(22) PCT Filed: Aug. 26, 2003
(86) PCT No.: PCT/BR03/00121

§ 371 Date: Apr. 12, 2005

(51) Int. Cl. A21B 1/00

(52) U.S. Cl. 126/19 R

(57) ABSTRACT

A shelf arrangement for ovens, whose cabinet (10) is provided with lateral walls (11) and a front opening (12) closed by a door (13) that is inferiorly and horizontally tiltable, said lateral walls (11) being provided with rails (14, 15), on which is slidingly seated at least one shelf (30). The shelf (30) is manually displaceable between a retracted operative position and a loading position, which is parallel, elevated, and outwardly displaced in relation to the operative position.

### FIELD OF THE INVENTION

The present invention refers to a constructive arrangement for one or more sliding shelves provided in the interior of an oven, usually an oven incorporated to a domestic stove, under the cooktop thereof.

### BACKGROUND OF THE INVENTION

The domestic stoves used nowadays, particularly the gas stoves provided with a cabinet placed directly on the floor or fitted in a workbench, are provided with an oven, for baking food and which is positioned, in a non-ergonomic way, below the cooktop of the stove, requiring the user to make undesirable efforts during the operations of inserting and removing the food in relation to the oven.

Aiming at reducing the effort required from the user and his discomfort when using the oven, there have been proposed constructive arrangements, in which one or all the shelves of the oven are automatically and horizontally displaced between an operative position, in which said shelves are retracted in the interior of the oven, and a loading position, partially projecting outwardly from the front opening of the oven, the horizontal displacement of the shelves being obtained by the displacement of the door of the oven between the open and closed positions thereof. These prior art solutions allow the user, upon opening the door of the oven, to have the shelf automatically forwardly displaced, exposing a larger extension of its support surface to the user and facilitating the operations of inserting and removing the food in relation to the oven.

However, in these known constructions, the shelves are displaced in the horizontal direction only, with no change in their height in relation to the floor. As the ovens are invariably disposed below the cooktop of the stove, the operational height of these shelves in relation to the floor is small, forcing the user to bend his body uncomfortably downwardly in order to access the support surface of the shelves, even when said shelves are forwardly displaced. Moreover, these known constructive solutions are ergonomically deficient.

### OBJECTS OF THE INVENTION

Due to the deficiency of the known prior art arrangements, it is an object of the present invention to provide a shelf arrangement for a cooking oven, which facilitates the operations of inserting, removing, and visualizing the product to be baked inside the oven, providing higher ergonomic levels in the postures that are required from the user to take the product to the oven, to follow up its cooking and to take it out from the oven at the end of the cooking process.

It is a further object of the invention to provide a shelf arrangement such as mentioned above, which allows the shelf to be displaced between a retracted position, inside the oven, and a loading position, in which the shelf is partially external in relation to the oven, by moving the door of the oven between its open and closed positions.

### SUMMARY OF THE INVENTION

The invention is applied to an oven, whose cabinet is provided with lateral walls, parallel to each other, and which define a front opening closed by a lower door, which is horizontally tiltable between a closed position, seated against the front opening, and an open position, forwardly projecting from the oven. There are provided rails on the lateral walls to support at least one shelf.

According to the invention, the shelf is mounted to the respective rails so as to be manually displaced, in a horizontal path, between an operative position, in which it is retracted in the interior of the oven, and a parallel loading position, in which it is elevated and outwardly displaced in relation to the operative position.

The shelf can be affixed to a frame comprising multiple shelves, and also be moved between its different operational positions by displacing the door of the oven.

### BRIEF DESCRIPTION OF THE DRAWINGS

The invention will be described below, with reference to the attached drawings, in which:

FIG. 1 is a schematic vertical sectional view of an oven provided with the present shelf arrangement, according to a first embodiment of the invention, in which the door of the oven is closed and the assembly of two shelves is in the operative position, retracted in the interior of the oven;

FIG. 2 is a similar view to that of FIG. 1, but showing the door of the oven slightly open and the two-shelf assembly in the intermediate position;

FIG. 3 is a similar view to those of FIGS. 1 and 2, but showing the door of the oven full open and the two-shelf assembly in the loading position;

FIG. 4 is a schematic vertical sectional view of an oven provided with the present shelf arrangement, according to a second embodiment of the invention, in which the door of the oven is closed and the arrangement of three shelves is in the operative position, retracted in the interior of the oven; and

FIGS. 5 and 6 are similar views to those of FIGS. 2 and 3, but illustrating the intermediate and the loading positions of the second embodiment of the invention of FIG. 4, respectively.

### DESCRIPTION OF THE ILLUSTRATED EMBODIMENT

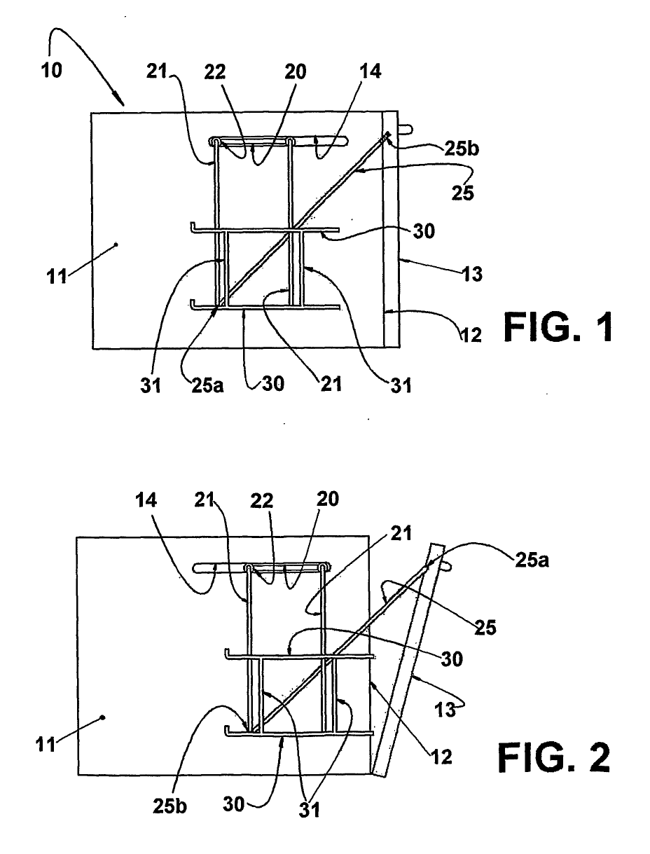

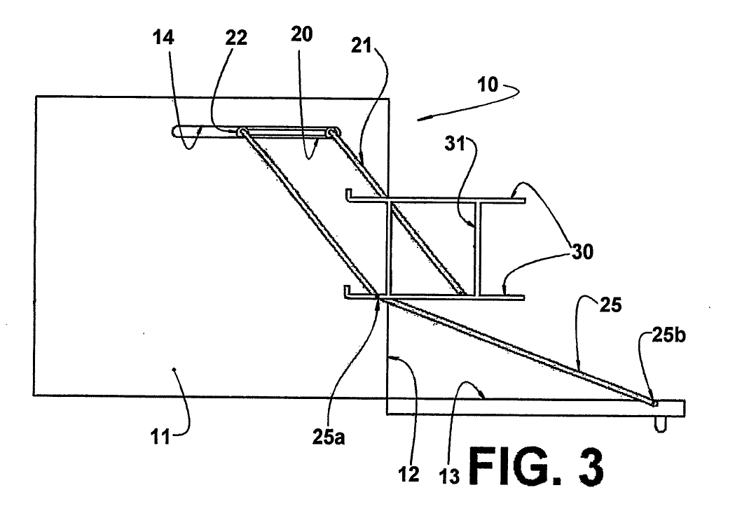

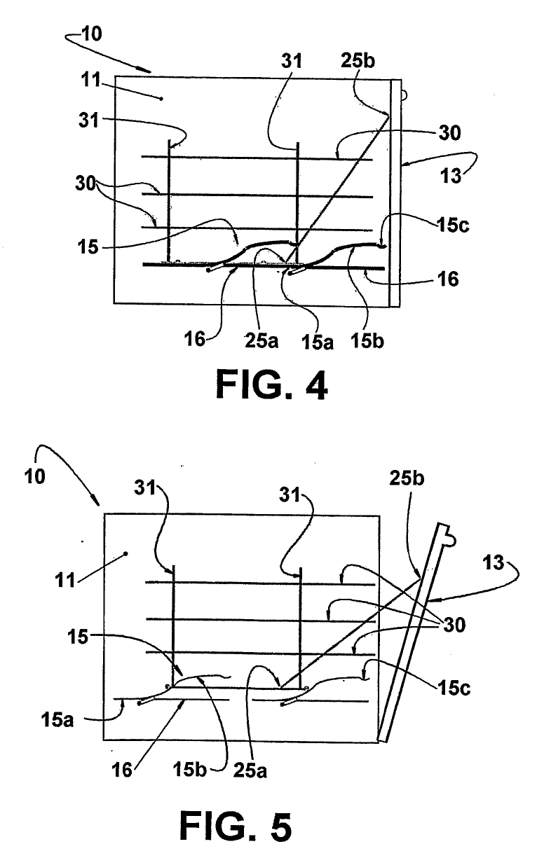

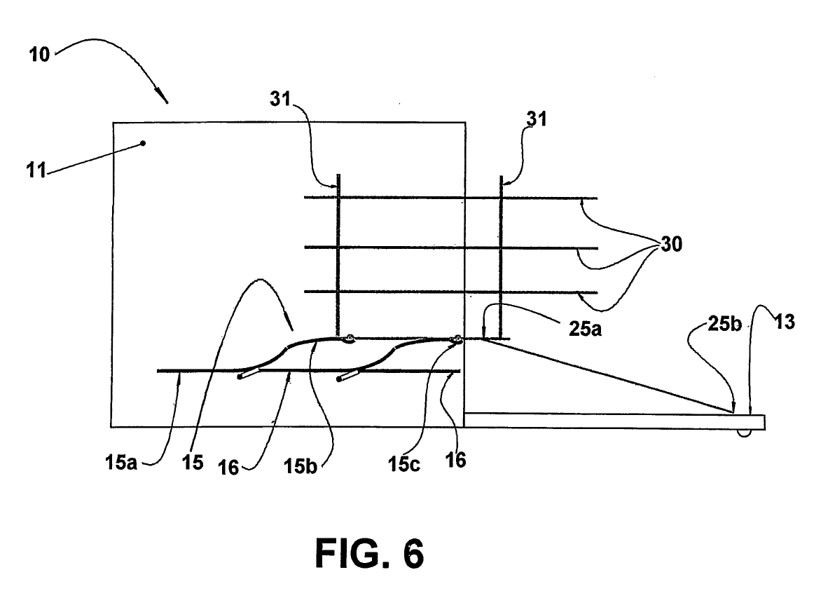

The present shelf arrangement is applicable to an oven, whose cabinet 10 comprises lateral walls 11, parallel to each other (only one is illustrated) and which define a front opening 12 closed by a door 13, which is inferiorly and horizontally tiltable between a closed position, in which it is seated against the front opening 12 (FIGS. 1 and 4) and an open position, projecting forwardly from the oven, as illustrated in FIGS. 3 and 6.

In the first embodiment illustrated in FIGS. 1-3, each lateral wall 11 of the cabinet 10 is provided with a rail 14, horizontally disposed and in which is mounted a slide 20 articulating the upper ends of a pair of suspension rods 21, whose lower ends are articulated to a corresponding side of a shelf 30, or an assembly of multiple shelves 30 that are affixed to only one frame 31.

In this first embodiment, the displacement of the slides 20 in the respective rails 14 allows the shelf 30 (or the assembly of shelves 30), suspended by the suspension rods 21, to be displaced between the operative position (illustrated in FIG. 1), and an intermediate position (illustrated in FIG. 2) adjacent to the front opening 12. This displacement of the shelf 30 between the operative and intermediate positions is horizontal or substantially horizontal.

From the intermediate position, the two slides 20 can no longer be forwardly displaced, as they have reached the front limit of the rails 14. In this condition, if the shelf 30 is pulled forwardly, with the door 13 adequately open, the suspension rods 21 will oscillate forwardly and upwardly, around the upper ends thereof, allowing the shelf 30 to be displaced to a loading position (illustrated in FIG. 3), in which it is parallel, elevated, and outwardly displaced in relation to the intermediate position. The horizontality of the shelf 30 is maintained due to the parallelism of each pair of suspension rods 21, which define articulations, in the form of a parallelogram, to support the shelf or shelves 30.

In order to make soft the displacement of the shelf 30, each slide 20 can be provided with two or more rollers 22 to seat on the respective rail 14.

As illustrated, the shelf 30 can be detachably coupled to the door 13 of the oven, so that the angular displacement of said door 13 produces the corresponding displacement of the shelf 30.

The coupling between the shelf 30 and the door 13 is usually obtained by a pair of mutually parallel driving rods 25, each having an internal end 25a detachably articulated to a corresponding side of the shelf 30, and an external end 25b detachably articulated to a corresponding side of the door 13.

With this construction, when the door 13 is in the closed position, the driving rods 25 displace the shelf 30 to the operative position (FIG. 1). With a certain movement of the door 13 towards the opening direction, the shelf 30 is forwardly pulled by the driving rods 25, and it is displaced from the operative position to the intermediate position illustrated in FIG. 2. By continuing the displacement to open the door 13, the shelf 30 is pulled by the driving rods 25 even more outwardly and upwardly, while the external ends 25b of the driving rods 25 are in a level that is higher than that of the internal ends 25a.

The dimensioning of the driving rods 25 is effected so that, in the maximum opening position of the door 13 of the oven, the external ends 25b of the driving rods 25 reach a position in a level slightly lower than that in which the internal ends 25a are horizontally displaced, allowing the shelf 30 to be stabilized in the loading position.

In the second embodiment illustrated of FIGS. 4-6, the shelf 30 can also be mounted to a single frame 31, carrying one ore more additional shelves 30, said shelf 30 or said frame 31 being likewise detachably coupled to the door 13 by a pair of driving rods 25, as already described in relation to the first embodiment.

In the second embodiment, each lateral wall 11 is provided with a pair of rails 15 to support respective portions, at the same side of the shelf 30 and which are longitudinally spaced from each other, each rail 15 comprising a first horizontal extension 15a, along which the shelf 30 is displaced between its operative and intermediate positions, and a second extension 15b, connected to the first extension 15a and which is upwardly inclined towards the front opening 12 and along which the shelf 30 is displaced between its intermediate and loading positions. To facilitate the displacement of the shelf 30, the latter can be provided, on each side thereof, with a pair of rollers 33, each roller 33 being seated on a respective rail 15.

In order to facilitate the stabilization of the shelf 30 in the elevated loading position, the second extension 15b of each rail terminates in a recess 15c to receive and retain the respective roller 33 of the shelf 30.

Each rail 15 may further comprise a third horizontal extension 16, arranged in series with the first extension 15a and below the second extension and which is optionally used to conduct the shelf 30 to a loading position which is coplanar and outwardly advanced in relation to the intermediate position.

While only two constructive ways of carrying out the present invention have been described and illustrated, it should be understood that other embodiments may be used, without departing from the constructive concept defined in the claims that accompany the present description.

1. A shelf arrangement for ovens of the type comprising cabinet (10) provided with lateral walls (11), parallel to each other and which define front opening (12) closed by lower door (13) which is horizontally tiltable between a closed position, seated against the front opening (12), and an open position, forwardly projected from the oven, said lateral walls (11) carrying rails (14, 15) on which is slidingly seated at least one shelf (30), characterized in that the shelf (30) is mounted to the respective rails (14, 15) in order to be manually displaceable between an operative position, in which it is retracted in the interior of the oven, and a parallel loading position, in which it is elevated and outwardly displaced in relation to the operative position, a pair of rails (15) being provided on each of the lateral walls (11) of the oven and on which respective mutually spaced portions of the corresponding side of the shelf (30) are seated, each rail (15) comprising a first horizontal extension (15a), on which the shelf (30) seats in its operative position, and a second extension (15b), connected to the first one and upwardly inclined towards the front opening (12) and along which the shelf (30) is displaced between its operative and loading positions.

2. A shelf arrangement according to claim 1, characterized in that the shelf (30) is affixed to a frame (31) comprising at least one more shelf (30) parallel to the first one.

3. A shelf arrangement according to claim 1, characterized in that the shelf (30) is detachably coupled to the door (13) of the oven, so that the angular displacement thereof between its closed and open positions produces the displacement of the shelf (30) between its operative and loading positions.

4. A shelf arrangement according to claim 2, characterized in that the shelf (30) is coupled to the door (13) by a pair of mutually parallel driving rods (25), each having an internal end (25a) detachably articulated to one of the sides of the shelf (30), and an external end (25b) detachably articulated to a corresponding side of the door (13).

5. A shelf arrangement according to claim 4, characterized in that the external ends (25b) of the driving rods (25) reach a level that is lower than that of the internal ends (25a) when the door (13) of the oven is taken to a maximum opening position.

6. A shelf arrangement according to claim 1, characterized in that the shelf (30) is manually displaceable, in a horizontal path, between the operative position and an intermediate position adjacent to the front opening (12), and in an upwardly and outwardly inclined path in relation to the oven, between the intermediate position and the loading position.

7. A shelf arrangement according to claim 1, characterized in that the shelf (30) is seated on the two pairs of rails (15) by means of rollers (33).

8. A shelf arrangement according to claim 1, characterized in that each rail (15) has its second extension (15b) ending in a recess (15c), to receive and retain the respective roller of the shelf (30), stabilizing the latter in the loading position.

9. A shelf arrangement according to claim 8, characterized in that each rail (15) comprises a horizontal third extension (16), arranged in series with the first extension (15a) and below the second extension, to be optionally used to conduct the shelf (30) to a loading position that is coplanar and outwardly advanced in relation to the operative position.

10. A shelf arrangement according to claim 2, characterized in that the shelf (30) is manually displaceable, in a horizontal path, between the operative position and an intermediate position adjacent to the front opening (12), and in an upwardly and outwardly inclined path in relation to the oven, between the intermediate position and the loading position.

11. A shelf arrangement according to claim 3, characterized in that the shelf (30) is manually displaceable, in a horizontal path, between the operative position and an intermediate position adjacent to the front opening (12), and in an upwardly and outwardly inclined path in relation to the oven, between the intermediate position and the loading position.

12. A shelf arrangement according to claim 4, characterized in that the shelf (30) is manually displaceable, in a horizontal path, between the operative position and an intermediate position adjacent to the front opening (12), and in an upwardly and outwardly inclined path in relation to the oven, between the intermediate position and the loading position.

13. A shelf arrangement according to claim 5, characterized in that the shelf (30) is manually displaceable, in a horizontal path, between the operative position and an intermediate position adjacent to the front opening (12), and in an upwardly and outwardly inclined path in relation to the oven, between the intermediate position and the loading position.
